(19) United States
(12) Patent Application Publication
(10) Pub. No.: US 2017/0013394 A1
(43) Pub. Date: Jan. 12, 2017

(54) Method of determining if personal belonging or space has been disturbed via Blutetooth Low Energy

(71) Applicant: Nathan Gregory Deeds, Novato, CA (US)

(72) Inventor: Nathan Gregory Deeds, Novato, CA (US)

(21) Appl. No.: 15/056,559

(22) Filed: Feb. 29, 2016

Related U.S. Application Data
(60) Provisional application No. 62/128,970, filed on Mar. 5, 2015.

(51) Int. Cl. H04W 4/00; H04W 12/02

(52) U.S. Cl. CPC H04W 4/008; H04W 12/02

(57) ABSTRACT

The present invention provides a method of detection disturbances of movement and light for semi-secure items via a bluetooth enabled ‘chip’ which will alert a cellular device within range of any changes via 1) gyroscope and 2) photocell or other light measuring device. Data collection from the device is started by pressing a button, after which a ten second period is afforded to place the device in location to be monitored. Upon the completion of the ten seconds, the device will take a ‘fingerprint’ of current conditions (light, position) and enter low energy state. If no environmental changes have been observed, the device will register a message indicating such on the cellular device once the cellular device comes in range. If environmental changes have been made, the device will indicate the disturbance type (light and/or movement) as well as the time the disturbance(s) occurred.

The device consists of electronics and sensors allowing the user to determine if their personal belongings or space have been disturbed.

The device will be an enclosure made of plastic/polymer or rubber containing electronics consisting of a 3-axis gyroscope and light (photo) sensor(s) as well a battery and method of electronic data storage (memory) along with a low energy Bluetooth antenna. The holes on the top and bottom, notated in attached drawing 1 Exterior, allow the light to enter the photocell.

The device will be manufactured on a one-piece circuit board with all components soldered/connected to the, with the exception of the battery which will be connected to the board via jumpers. The component layout is notated in the attached drawing 2, Interior.

The device will begin to monitor it's environment via environmental polling via activation from a connected Bluetooth device (mobile/cellular phone Application) and store any changes in detected environment/device state to the onboard memory.

The device will communicate changes in environment/device state back to the mobile device continuously, as notated in attached drawing 3 Mobile/Cellular application component.

In the event the mobile device is ‘out of range’, the device will store the environmental/device states obtained via polling and send back to the device when in range. The device will alert the user if the environment/device has changed (eg movement via activation of the 3-axis gyroscope and/or lighting changes due to photocell activity).

### BRIEF DESCRIPTION OF THE DRAWINGS

FIG. 1, Exterior of device—

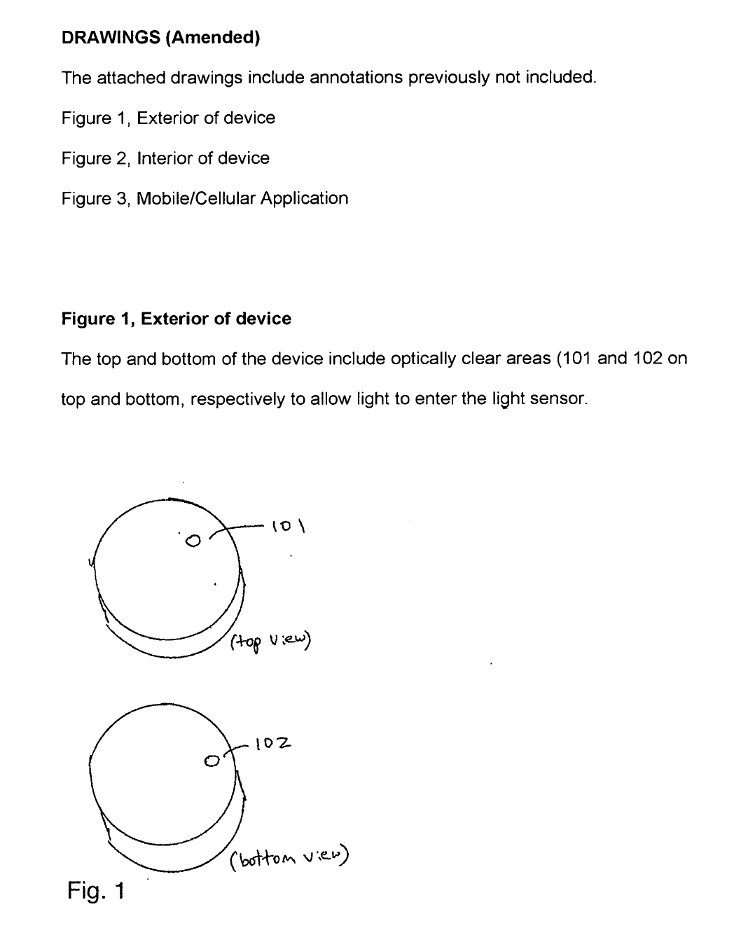

The top and bottom of the device include optically clear areas (101 and 102 on top and bottom, respectively to allow light to enter the light sensor.

FIG. 2, Interior of device

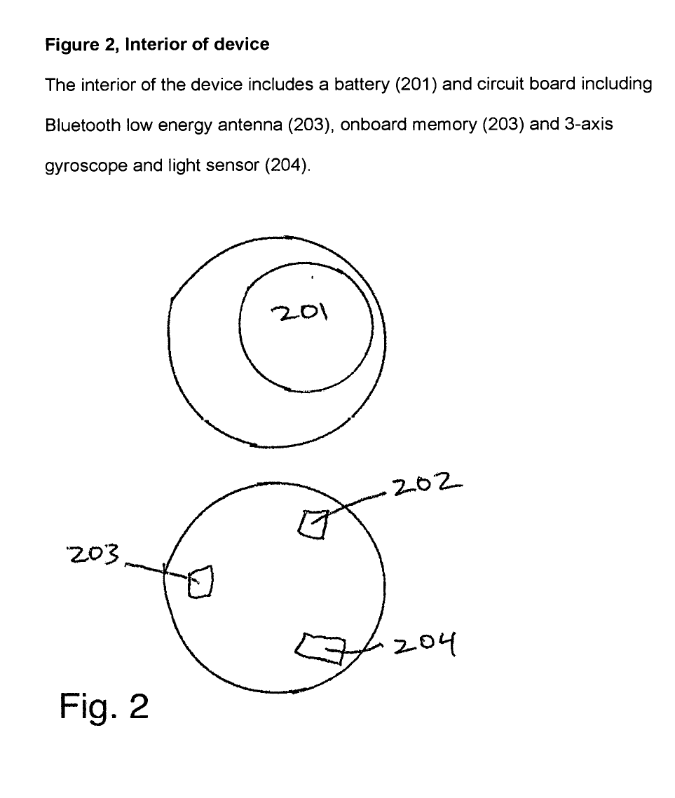

The interior of the device includes a battery (201) and circuit board including Bluetooth low energy antenna (203), onboard memory (203) and 3-axis gyroscope and light sensor (204).

FIG. 3, Mobile/Cellular Application

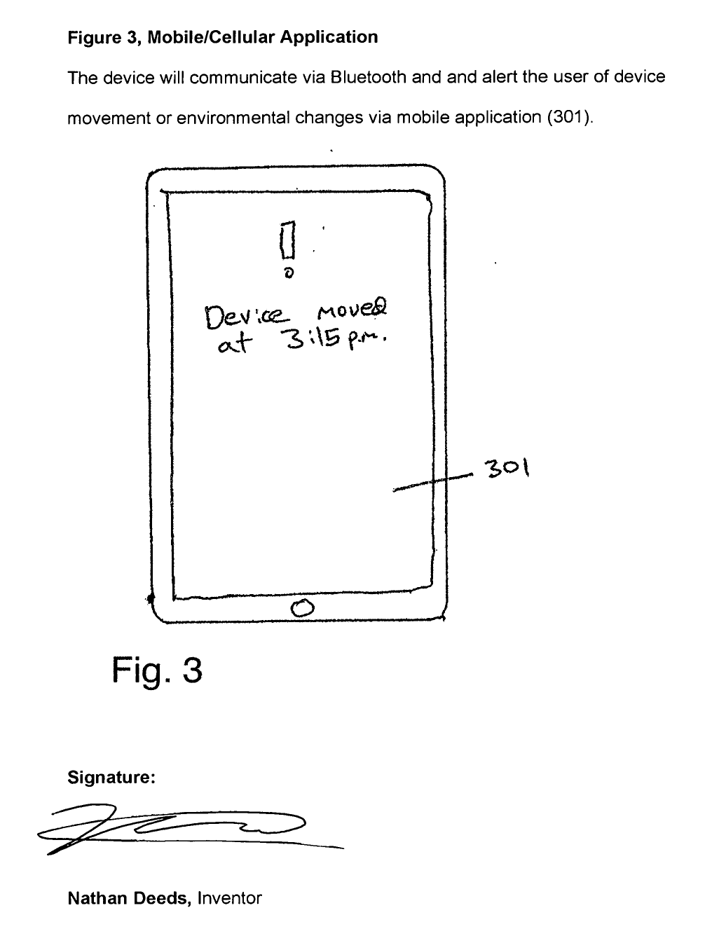

The device will communicate via Bluetooth and alert the user of device movement or environmental changes via mobile application (301).

1. A circuit board with a light sensor and 3-axis gyroscope wherein said sensors store device and environmental data to onboard memory and communicate said device and environmental data to a mobile/cellular device via Bluetooth low energy and mobile application.

2. Such a device will allow the owner to determine if the device or it's environment have been changed or manipulated
